(19) United States
(12) Patent Application Publication
(10) Pub. No.: US 2022/0356336 A1
(43) Pub. Date: Nov. 10, 2022

(54) THERMOPLASTIC COMPOSITE FOR AN ANTENNA COMPONENT

(71) Applicant: ROGERS CORPORATION, Chandler, AZ (US)

(72) Inventor: William Blasius, Charlton, MA (US)

(21) Appl. No.: 17/738,348

(22) Filed: May 6, 2022

Related U.S. Application Data
(60) Provisional application No. 63/186,511, filed on May 10, 2021.

(51) Int. Cl. C08L 23/16; H01Q 1/38

(52) U.S. Cl. CPC C08L 23/16; H01Q 1/38; C08L 2203/206; C08L 2207/04

(57) ABSTRACT

In an aspect, a thermoplastic composite comprises a polypropylene; a plurality of glass fibers; wherein the glass fibers comprise boric acid and CaO, both based on the total weight of the glass fibers; a plurality of clay platelets; and a plurality of clay rods; and wherein the thermoplastic composite comprises 0.5 to 10 weight percent of the of the sum of the plurality of clay platelets and the plurality of the clay nanorods based on the total weight of the thermoplastic composite. In another aspect, an article comprises an antenna array; a reflecting layer located on a surface of the antenna array; and a spacer layer comprising a thermoplastic component located in between the antenna array and the reflecting layer, wherein the thermoplastic composite comprises a thermoplastic polymer; a plurality of glass fibers; a plurality of clay platelets; and a plurality of clay rods.

### CROSS-REFERENCE TO RELATED APPLICATION

This application claims the benefit of U.S. Provisional Patent Application Ser. No. 63/186,511 filed May 10, 2021. The related application is incorporated herein in its entirety by reference.

### TECHNICAL FIELD

This disclosure relates to a thermoplastic composite that can be used as a spacer layer in an antenna.

### BACKGROUND

Spacers have been used in antennas in order to maintain a constant gap between antenna arrays and an outer reflecting skin. Developing such a material for use as a spacer is challenging as the material for the spacer layer should have a low coefficient of thermal expansion (CTE) that matches the copper cladding making up the antenna arrays, a low permittivity, and high melt flowability to fill out large, multichannel mold cavities. While various polymers have been considered for this spacer layer, they often do not meet one or more of the desired specifications. For example, while polyethylene has a low permittivity, it has a high CTE of 200 parts per million/degree Celsius (ppm/° C.), which is significantly higher than that of copper at 17 ppm/° C. Conversely, while polyphenylene ether with E-glass fillers has displayed reduced CTE values, these compositions generally do not have desired permittivity or flow properties.

An improved thermoplastic composite that can be used as a spacer layer in an antenna is therefore desired.

### BRIEF SUMMARY

Disclosed herein is a thermoplastic composite that can be used as a spacer layer.

In an aspect, a thermoplastic composite comprises 50 to 80 weight percent of a polypropylene based on the total weight to the thermoplastic composite; 10 to 45 weight percent a plurality of glass fibers based on the total weight of the thermoplastic composite; wherein the glass fibers comprise greater than or equal to 12 weight percent of boric acid (B₂O₃) and less than or equal to 15 weight percent of CaO, both based on the total weight of the glass fibers; a plurality of clay platelets; wherein an average value of the maximum length of the platelets is less than or equal to 200 nanometers; wherein an average thickness of the clay platelets is 1 to 10 nanometers; and a plurality of clay rods; wherein an average value of the length of the clay rods is 50 to 600 nanometers; and an average value of the diameter of the clay rods is 5 to 70 nanometers; and wherein the thermoplastic composite comprises 0.5 to 10 weight percent of the of the sum of the plurality of clay platelets and the plurality of the clay nanorods based on the total weight of the thermoplastic composite.

In another aspect, an article comprises an antenna array; a reflecting layer located on a surface of the antenna array; and a spacer layer comprising a thermoplastic component located in between the antenna array and the reflecting layer, wherein the thermoplastic composite comprises a thermoplastic polymer comprising at least one of a polyolefin, a poly(phenylene ether), a polymethylpentene, or a syndiotactic polystyrene; a plurality of glass fibers; a plurality of clay platelets; and a plurality of clay rods.

The above described and other features are exemplified by the following FIGURE, detailed description, and claims.

### BRIEF DESCRIPTION OF THE DRAWING

The following FIGURE is an exemplary embodiment, which is provided to illustrate the present disclosure, it is not intended to limit devices made in accordance with the disclosure to the materials, conditions, or process parameters set forth herein.

The FIGURE is an illustration of an antenna comprising a spacer layer.

### DETAILED DESCRIPTION

It was discovered that a thermoplastic composite comprising a thermoplastic polymer, a plurality of glass fibers, and a clay comprising a plurality of platelets and a plurality of rods displays a good balance of properties such that it can be used as a spacer layer in an antenna. The thermoplastic composite displays a flowability enhancement due to the mixed morphology of the clay and an improvement in the dielectric properties due to the glass fibers to result in an easy flowing thermoplastic composite with superior dielectric properties at 10 GHz. Importantly, the thermoplastic composite can achieve a coefficient of thermal expansion that more closely matches that of copper of less than or equal to 30 parts per million, or 15 to 25 parts per million per degree Celsius as determined in accordance with ASTM E1545-11(2016) at 40 to 100° C.

It is noted that while the disclosure focuses on spacer layers for use in an antenna, this thermoplastic composite can likewise be used in other applications where a low coefficient of thermal expansion (CTE), a low permittivity, and good melt flow properties are needed. For example, the thermoplastic composite can be used in blow molding or injection molding applications. The thermoplastic composite can be a lens or a radom.

The thermoplastic polymer can comprise at least one of a polyolefin, a poly(phenylene ether), polymethylpentene, or a syndiotactic polystyrene. Inclusion of polymethylpentene or a syndiotactic polystyrene can increase the thermal resistance of the thermoplastic composite. The thermoplastic polymer can comprise at least one of a polyolefin, polymethylpentene, or a syndiotactic polystyrene. The thermoplastic polymer can have a melt flow index of 0.3 to 70 grams per 10 minutes (g/10 min), or 10 to 30 g/10 min measured in accordance with ASTM D1238-20 at a temperature of 230° C. and a weight of 2.16 kilograms (kg).

The thermoplastic polymer can comprise a polyolefin. The polyolefin can comprise at least one of a homopolymer (for example, polyethylene (such as low density polyethylene or high density polyethylene), polypropylene, or an alpha-olefin polymer (such as a C₃₋₁₀ alpha-olefin polymer)), a copolymer comprising at least two of ethylene, propylene, or C₃₋₁₀ alpha-olefin units), or a partially or fully halogenated analog of any of the foregoing. The polyolefin can comprise a polypropylene. The polypropylene can comprise at least one of a polypropylene homopolymer or a polypropylene copolymer. The polypropylene copolymer can comprise at least one of a random copolymer, a block copolymer, or a heterophasic copolymer. The heterophasic propylene copolymer can comprise an elastomeric propylene copolymer (E) that is dispersed in a polypropylene matrix.

The polypropylene can comprise an acid or acid anhydride-modified polypropylene. The incorporation of a small amount of an acid or acid anhydride-modified polypropylene can comprise 1 to 10 weight percent of the acid or acid anhydride-modified polypropylene based on the total weight of the polypropylene.

The polypropylene can comprise a clarified polypropylene. Clarified polypropylenes are polypropylenes that are generally more transparent as compared to polypropylene homopolymers or polypropylene block copolymers. The clarified polypropylene can comprise 1 to 5 mol % of repeat units derived from ethylene. The clarified polypropylene can comprise at least one of a clarifying additive or a nucleation inhibitor that can prevent or reduce the crystallinity of the clarified polypropylene.

The thermoplastic composite can comprise 50 to 80 weight percent (wt %), or 55 to 70 weight percent of the thermoplastic polymer based on the total weight of the thermoplastic composite.

The thermoplastic composite can comprise a plurality of glass fibers. The glass fibers can comprise chopped glass fibers. The glass fibers can have an average length of 0.5 to 50 millimeters (mm), or 1 to 25 mm, or 5 to 10 mm. An average fiber diameter of the glass fibers can be 2 to 50 micrometers, or 10 to 15 micrometers. The plurality of glass fibers can comprise at least one of NE glass, D glass, pure silica glass, or quartz fibers.

The plurality of glass fibers can comprise greater than or equal to 12 weight percent, or 15 to 25 weight percent of boric acid (B₂O₃). The plurality of glass fibers can comprise less than or equal to 15 weight percent, or 0 to 10 weight percent, or 0 to 1 weight percent of CaO. Examples of such glass fibers include both NE glass and D glass. NE glass and D glass can comprise a lower contents of alkaline earth metals (such as CaO and MgO) and a higher amount of boric acid relative to traditional E glass that generally includes 5 to 10 weight percent of boric acid, 16 to 25 weight percent of CaO, and 0 to 5 weight percent of MgO. As a result, the NE glass and the D glass can have a lower permittivity and a lower dielectric loss tangent as compared to traditional E glass. The NE glass can have at least one of a permittivity of less than 5 or a dielectric loss tangent of less than 0.002 at 1 gigahertz. The D glass can have at least one of a permittivity of less than 4.5 or a dielectric loss tangent of less than 0.0032 at 10 gigahertz.

The thermoplastic composite can comprise 10 to 45 weight percent, or 25 to 35 weight percent of the glass fibers based on the total weight of the thermoplastic composite.

The thermoplastic composite can comprise a clay. The clay can comprise an organophilic phyllosilicate. The clay can comprise a bentonite. The clay can comprise kaolin. The clay can comprise montmorillonite. The clay can comprise at least one of saponite, nontronite, beidellite, or hectorite The clay can be free of a surface treatment.

The clay can comprise a plurality of clay platelets and a plurality of clay rods. An average maximum length of both the clay platelets and the clay rods can be less than or equal to 600 nanometers, or less than or equal to 500 nanometers. An average value of the maximum length of the clay platelets can be 50 to 600 nanometers, or 50 to 200 nanometers, or 75 to 150 nanometers. The clay platelets can have an average thickness of 1 to 10 nanometers, or 1 to 5 nanometers. An average value of the length of the clay rods can be 50 to 600 nanometers, or 100 to 500 nanometers. An average value of the diameter of the clay rods can be 5 to 70 nanometers, or 10 to 50 nanometers.

The thermoplastic composite can comprise 0.5 to 10 weight percent, or 1 to 5 weight percent of the sum of the plurality of clay platelets and the plurality of the clay nanorods based on the total weight of the thermoplastic composite.

The thermoplastic composite can be a solid material that is free of a void space. Conversely, the thermoplastic composite can be a foam, for example, having a porosity of 1 to 80 volume percent, or 10 to 50 volume percent based on the total volume of the thermoplastic composite. The foam can comprise at least one of a chemically blown foam, a physically blown foam, or a syntactic foam that includes a plurality of hollow spheres.

If a blowing agent is used, the blowing agent can comprise at least one of a physical blowing agent or a chemical blowing agent. The physical blowing agent can include at least one of a hydrocarbon (for example, a C₁₋₆ hydrocarbon including a linear C₁₋₆ alkane, a branched C₁₋₆ alkane, a cyclic C₁₋₆ alkane, an ether, or an ester), a partially halogenated hydrocarbon (for example, a linear, branched, or cyclic C₁₋₆ fluoroalkane), nitrogen, oxygen, argon, or carbon dioxide. Specific physical blowing agents include a chlorofluorocarbon (for example, 1,1-dichloro-1-fluoroethane, 1,1-dichloro-2,2,2-trifluoro-ethane, monochlorodifluoromethane, or 1-chloro-1,1-difluoroethane); a fluorocarbon (for example, 1,1,1,3,3,3-hexafluoropropane, 2,2,4,4-tetrafluorobutane, 1,1,1,3,3,3-hexafluoro-2-methylpropane, 1,1,1,3,3-pentafluoropropane, 1,1,1,2,2-pentafluoropropane, 1,1,1,2,3-pentafluoropropane, 1,1,2,3,3-pentafluoropropane, 1,1,2,2,3-pentafluoropropane, 1,1,1,3,3,4-hexafluorobutane, 1,1,1,3,3-pentafluorobutane, 1,1,1,4,4,4-hexafluorobutane, 1,1,1,4,4-pentafluorobutane, 1,1,2,2,3,3-hexafluoropropane, 1,1,1,2,3,3-hexafluoropropane, 1,1-difluoroethane, 1,1,1,2-tetrafluoroethane, or pentafluoroethane); a fluoroether (for example, methyl-1,1,1-trifluoroethylether or difluoromethyl-1,1,1-trifluoroethylether); or a hydrocarbon (for example, n-pentane, isopentane, or cyclopentane). The physical blowing agent can comprise at least one of carbon dioxide or nitrogen.

Examples of chemical blowing agents include those that decompose to form gas. The chemical blowing agent can comprise at least one of water, azoisobutyronitrile, azodicarbonamide (for example, azo-bis-formamide), barium azodicarboxylate, a substituted hydrazine (for example, diphenylsulfone-3,3′-disulfohydrazide, 4,4′-hydroxy-bis-(benzenesulfohydrazide), trihydrazinotriazine, or aryl-bis-(sulfohydrazide)), a semicarbazide (for example, p-tolylene sulfonyl semicarbazide or 4,4′-hydroxy-bis-(benzenesulfonyl semicarbazide)), a triazole (for example, 5-morpholyl-1,2,3,4-thiatriazole), an N-nitroso compound (for example, N,N′-dinitrosopentamethylene tetramine or N,N-dimethyl-N,N′-dinitrosophthalmide), or a benzoxazine (for example, isatoic anhydride). The chemical blowing agent can comprise an endothermic foaming agent, for example, at least one of monosodium citrate or sodium bicarbonate.

The foam can comprise a syntactic foam that refers to a solid material that is filled with hollow particles, in particular spheres or hollow nanotubes (for example, hollow kaolin nanotubes). The hollow particles can comprise at least one of ceramic hollow particles, polymeric hollow particles, or glass hollow particles (such as those made of an alkali borosilicate glass). The syntactic foam can comprise 1 to 70 vol %, or 5 to 70 vol %, or 10 to 50 vol % of the hollow particles based on the total volume of the foam layer. The microparticles can have a mean diameter of less than or equal to 300 micrometers, or 15 to 200 micrometers, or 20 to 70 micrometers. Compared to other types of foams, syntactic foams can have one or more of a better mechanical stability, a better coefficient of thermal expansion matching with the via material, or a reduced moisture absorption.

The thermoplastic composite can comprise one or more optional additives. The additive can comprise at least one of a polyhedral oligomeric silsesquioxane, a dielectric filler (for example, silica (for example, colloidal or fumed silica) or wollastonite), a hydrogen terminated nanodiamond, graphene, a stabilizer (for example, a hindered amine light stabilizer), an acid scavenger, an antioxidant, a metal deactivator, a slip agent, a colorant, a flame retardant, or a mold release agent. The additive can comprise at least one of a hydrogen terminated nanodiamond, graphene, polyhedral oligomeric silsesquioxane, silica, or wollastonite.

The thermoplastic composite can comprise a polyhedral oligomeric silsesquioxane (commonly referred to as “POSS”, also referred to herein as the “silsesquioxane”). The silsesquioxane is a nano-sized inorganic material with a silica core that can have reactive functional groups on the surface. The silsesquioxane can have a cube or a cube-like structure comprising silicon atoms at the vertices and interconnecting oxygen atoms. Each of the silicon atoms can be covalently bonded to a pendent R group. Silsesquioxanes, such as octa(dimethylsiloxy) silsesquioxane (R₈Si₈O₁₂), comprise a cage of silicon and oxygen atoms around a core with eight pendent R groups. Each R group independently can be a hydrogen, a hydroxy group, an alkyl group, an aryl group, an alkene group, where the R group can comprise one to twelve carbon atoms and one or more heteroatoms (for example, oxygen, nitrogen, phosphorus, silicon, or a halogen). Each R group independently can comprise at least one of a reactive group such as an alcohol, an epoxy group, an ester, an amine, a ketone, an ether, or a halide. Each R group independently can comprise at least one of a silanol, an alkoxide, or a chloride. The silsesquioxane can comprise at least one of trisilanolphenyl POSS, dodecaphenyl POSS, octaisobutyl POSS, or octamethyl POSS. The silsesquioxane can comprise trisilanolphenyl POSS. The silsesquioxane can be present in an amount of 0.05 to 5 weight percent, or 0.5 to 2 weight percent based on the total weight of the thermoplastic composite.

The thermoplastic composite can have a gravimetric melt flow index (MFI) of greater than or equal to 20 grams per 10 minutes (g/10 min), or 20 to 30 g/10 min measured in accordance with ASTM-D1238-20 at a temperature of 230° C. and a weight of 2.16 kilograms (kg).

The thermoplastic composite can have a melt volumetric flow rate (MVR) of greater than or equal to 15 centimeters cubed per 10 minutes (cc/10 min), or 15 to 30 cc/10 min determined in accordance with ASTM-D1238-20 at a temperature of 230° C. and a weight of 2.6 kilograms.

The thermoplastic composite can have a coefficient of thermal expansion of less than or equal to 30 parts per million per degree Celsius (ppm/° C.), or 15 to 25 parts per million parts per million per degree Celsius as determined in accordance with ASTM E1545-11(2016) at 40 to 100° C. on a 0.40 inch (1.02 millimeter) thick sample in the flow direction.

The thermoplastic composite can have a permittivity (Dk) at 10 gigahertz (GHz) of 1.5 to 10, or 1.5 to 4, or 1.5 to 3, or 1.5 to 2.8. The thermoplastic composite can have a dielectric loss tangent (Df) of less than or equal to 0.005, or 0.0005 to 0.005. The dielectric properties can be determined in accordance with ASTM D3380-14 at 10 gigahertz (GHz).

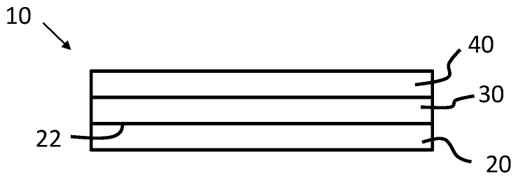

An article can comprise the thermoplastic composite. The article can be an antenna and the thermoplastic composite can be used as a spacer layer in the antenna. For example, the article can comprise an antenna array; a reflecting layer located on a surface of the antenna array; and a spacer layer comprising a thermoplastic component located in between the antenna array and the reflecting layer. FIG. 1 is an illustration of such an article 10 that comprise an antenna array 20; a reflecting layer 40 located on a surface 22 of the antenna array 20; and a spacer layer 30 comprising a thermoplastic component located in between the antenna array 20 and the reflecting layer 40.

The thermoplastic composite can comprise a thermoplastic polymer (for example polypropylene), a plurality of glass fibers, a plurality of clay platelets, and a plurality of clay rods. The thermoplastic composite can comprise 50 to 80 weight percent, or 55 to 70 weight percent of a polypropylene based on the total weight to the thermoplastic composite. The thermoplastic composite can comprise 10 to 45 weight percent, or 25 to 35 weight percent a plurality of glass fibers based on the total weight of the thermoplastic composite. The glass fibers can comprise greater than or equal to 12 weight percent, or 15 to 25 weight percent of boric acid (B₂O₃) and less than or equal to 15 weight percent, or 0 to 10 weight percent, or 0 to 1 weight percent of CaO, both based on the total weight of the glass fibers. The clay platelets can have an average value of the maximum length of the platelets of to 200 nanometers, or 75 to 150 nanometers. The clay platelets can have an average thickness of the clay platelets of 1 to 10 nanometers, or 1 to 5 nanometers. The clay rods can have an average value of the length of the clay rods of 50 to 600 nanometers, or 100 to 500 nanometers. The clay rods can have an average value of the diameter of the clay rods of 5 to 70 nanometers, or 10 to 50 nanometers. The thermoplastic composite can comprise 0.5 to 10 weight percent, or 1 to 5 weight percent of the of the sum of the plurality of clay platelets and the plurality of the clay nanorods based on the total weight of the thermoplastic composite. The thermoplastic composite can have a coefficient of thermal expansion of less than or equal to 30 parts per million, or 15 to 25 parts per million per degree Celsius as determined in accordance with ASTM E1545-11(2016) at 40 to 100° C. The polypropylene can be a copolymer including repeat units derived from ethylene. The glass fibers have at least one of an average length of 0.5 to 50 millimeters, or 1 to 25 mm, or 5 to 10 mm; or an average fiber diameter of the glass fibers can be 2 to 50 micrometers, or 10 to 15 micrometers. At least one of the plurality of claim platelets or the plurality of clay rods can comprise montmorillonite. The thermoplastic composite can have a porosity of 1 to 80 volume percent, or 10 to 50 volume percent based on the total volume of the thermoplastic composite. The thermoplastic composite can further comprise at least one of a hydrogen terminated nanodiamond, polyhedral oligomeric silsesquioxane, silica, or wollastonite.

An article can comprise an antenna array; a reflecting layer located on a surface of the antenna array; and a spacer layer comprising a thermoplastic component located in between the antenna array and the reflecting layer. The thermoplastic composite can comprise a thermoplastic polymer comprising at least one of a polyolefin, a poly(phenylene ether), a polymethylpentene, or a syndiotactic polystyrene; a plurality of glass fibers; a plurality of clay platelets; and a plurality of clay rods. The thermoplastic composite can be the thermoplastic composite described above. The thermoplastic composite can have a coefficient of thermal expansion of less than or equal to 30 parts per million per degree Celsius, or 15 to 25 parts per million per degree Celsius as determined in accordance with ASTM E1545-11(2016) at 40 to 100° C. The thermoplastic polymer can comprise a polypropylene that includes repeat units derived from ethylene. The thermoplastic polymer can be present in an amount of 50 to 80 weight percent, or 55 to 70 weight percent of the thermoplastic polymer based on the total weight of the thermoplastic composite. The glass fibers can comprise at least one of pure silica glass fibers or quartz fibers. The glass fibers can comprise greater than or equal to 12 weight percent, or 15 to 25 weight percent of boric acid (B₂O₃) and less than or equal to 15 weight percent, or 0 to 10 weight percent, or 0 to 1 weight percent of CaO, both based on the total weight of the glass fibers. The glass fibers can have at least one of an average length of 0.5 to 50 millimeters, or 1 to 25 mm, or 5 to 10 mm. An average fiber diameter of the glass fibers can be 2 to 50 micrometers, or 10 to 15 micrometers. The plurality of the platelets or the plurality of clay rods can comprise montmorillonite. An average value of the maximum length of the platelets can be to 200 nanometers, or 75 to 150 nanometers. An average thickness of the clay platelets can be 1 to 10 nanometers, or 1 to 5 nanometers. An average value of the length of the clay rods can be 50 to 600 nanometers, or 100 to 500 nanometers. An average value of the diameter of the clay rods can be 5 to 70 nanometers, or 10 to 50 nanometers. The thermoplastic composite can comprise 0.5 to 10 weight percent, or 1 to 5 weight percent of the of the sum of the plurality of clay platelets and the plurality of the clay nanorods based on the total weight of the thermoplastic composite. The thermoplastic composite can have a porosity of 1 to 80 volume percent, or 10 to 50 volume percent based on the total volume of the thermoplastic composite. The thermoplastic composite can further comprise at least one of a hydrogen terminated nanodiamond, polyhedral oligomeric silsesquioxane, silica, or wollastonite.

An article can comprise an antenna array; a reflecting layer located on a surface of the antenna array; and a spacer layer comprising a thermoplastic component located in between the antenna array and the reflecting layer. The thermoplastic composite can comprise 55 to 70 weight percent of polypropylene; 25 to 35 weight percent of a plurality of glass fibers; wherein the glass fibers have at least one of an average length of 0.5 to 50 millimeters, or 1 to 25 mm, or 5 to 10 mm, or an average fiber diameter of the glass fibers can be 2 to 50 micrometers, or 10 to 15 micrometers; and wherein the glass fibers comprise greater than or equal to 12 weight percent, or 15 to 25 weight percent of boric acid and less than or equal to 15 weight percent, or 0 to 10 weight percent, or 0 to 1 weight percent of CaO, both based on the total weight of the glass fibers; a plurality of clay platelets; wherein an average value of the maximum length of the platelets is less than or equal to 200 nanometers, or 75 to 150 nanometers; or wherein an average thickness of the clay platelets is 1 to 10 nanometers, or 1 to 5 nanometers; and a plurality of clay rods; wherein an average value of the length of the clay rods is 50 to 600 nanometers, or 100 to 500 nanometers; or wherein an average value of the diameter of the clay rods is 5 to 70 nanometers, or 10 to 50 nanometers; and wherein the thermoplastic composite comprises 0.5 to 10 weight percent, or 1 to 5 weight percent of the of the sum of the plurality of clay platelets and the plurality of the clay nanorods based on the total weight of the thermoplastic composite; and wherein the thermoplastic composite has a coefficient of thermal expansion of less than or equal to 30 parts per million, or 15 to 25 parts per million per degree Celsius as determined in accordance with ASTM E1545-11(2016) at 40 to 100° C.

Forming the thermoplastic composite is not particularly limited. For example, the forming can include mixing in a melt mixer or extruding. The thermoplastic composite can be prepared by extruding a composition comprising at least the thermoplastic polymer, the plurality of glass fibers, and the plurality of clay platelets; and the plurality of clay rods. The extrusion can be performed using a twin screw extruder with multiple material feed ports. The method can comprise feeding the thermoplastic polymer through a main feed throat of the extruder to form a melt, feeding the plurality of clay platelets and the plurality of clay rods into the melt, and feeding the glass fibers into the melt. The feeding of the glass fibers can occur downstream of the feeding of the respective clays. The feeding of the glass fibers can occur upstream of a die adapter. Adding the glass fibers downstream of the nanoclay and an optional stabilizer can minimize at least one of agglomeration of the nanoclay or breakage of the glass fibers. The thermoplastic composite can be formed into strands, for example, by pushing through a die plate, cooled in a water bath, forced air dried, and chopped into pellets.

The thermoplastic composite can be molded to form an article of a desired size and shape. For example, the strands or pellets of the thermoplastic composite can be fed into an injection molding machine where they can be melted, compacted, and forced into mold cavity to form an article.

The following examples are provided to illustrate the present disclosure. The examples are merely illustrative and are not intended to limit devices made in accordance with the disclosure to the materials, conditions, or process parameters set forth therein.

### EXAMPLES

In the examples, the mixing torque in milligrams (mg) was measured at 4 minutes, a temperature of 230 degrees Celsius (° C.), and a mixing speed of 75 revolutions per minute (rpm).

The gravimetric melt flow index (MFI) was measured in accordance with ASTM D1238-20 at a temperature of 230° C. and a weight of 2.16 kilograms (kg). The melt volumetric flow rate (MVR) was determined in accordance with ASTM D1238-20 at a temperature of 230° C. and a weight of 2.16 kilograms. The melt flow properties were measured on a Tinius Olsen Extrusion Plastometer Model MP600.

The coefficient of thermal expansion in parts per million per degree Celsius was determined in accordance with ASTM E1545-11(2016). CTE experiments were performed on compression molded plaques with an induced flow direction and tested on a TA Instruments TMA450 from −40 C to 110° C.

Permittivity (Dk) and dielectric loss tangent (Df) were determined on a compression molded plaque by a Long Strip Line (LSL) method ASTM D3380-14.

The components used in the examples are shown in Table 1.

TABLE 1

| Component | Description | Source |
|---|---|---|
| Random | 5122C3, a clarified random copolymer | Pinnacle |
| polypropylene | | |
| NE Glass fibers | NE glass, Chopped glass fibers | Nittobo |
| E Glass fibers | E glass fibers, Chopped glass fibers | SILMIM LLC |
| Max CT | BYK-MAX CT 4270, an organophilic | BYK-Chemie |
| Nanoclay | phyllosilicate | GmbH |
| Cloisite 20 | CLOISITE 20, a bis(hydrogenated | BYK-Chemie |
| nanoclay | tallow alkyl)dimethyl, salt with | GmbH |
| | bentonite | |

### Examples 1-5

Three thermoplastic composites were prepared. The thermoplastic composites were prepared by compounding the components as shown in Table 2 in a CW BRABENDER Intelli-Torque rheometer with a three piece, 50 centimeter cubed (cc) mixing bowl with roller mixing blades. The mixer temperature was set to 220° C. and at a mixer blade speed of 75 revolutions per minute (rpm). A polypropylene copolymer was melted in the mixer, followed by addition of the glass and nanoclay if present. After mixing for 5 minutes, the mixer was stopped, disassembled and the molten composition was removed to cool to form the thermoplastic composite.

TABLE 2

| Example | 1 | 2 | 3 |
|---|---|---|---|
| Polypropylene (wt %) | 100 | 69 | 65 |
| NE glass fibers (wt %) | — | 31 | 31 |
| Max CT nanoclay (wt %) | — | — | 4 |

The properties of the thermoplastic composites were measured and are shown in Table 3. These properties are compared to two commercially available materials in Examples 4 and 5. In Example 4, the thermoplastic composition was NORYL PPX 630 commercially available from SABIC. In Example 5, the thermoplastic composition was THERMYLENE P6-4OFG-0100 commercially available from Asahi Kasei. The values in Table 3 were either measured or were taken from the respective data sheets using their disclosed test methods.

TABLE 3

| Example | 1 | 2 | 3 | 4 | 5 |
|---|---|---|---|---|---|
| Mixing torque (mg) | — | 476 | 389 | — | — |
| MFI (g/10 min) | 12 | 15.3 | 23.6 | — | 7 |
| MVR (cc/10 min) | 13.3 | 13.6 | 21.1 | 3* | 5.6 |
| CTE (ppm/° C.) | ~170 | 37 | 18 | 20 | — |
| Permittivity at 10 GHz | — | 2.56 | 2.61 | ~2.8 | 2.8 |
| Dielectric loss at 10 GHz | — | 0.002 | 0.003 | — | 0.003 |

*(Determined at 260° C./5 kg)

In comparing Example 3 to Examples 1 and 2, Table 3 shows incorporating a small amount of nanoclay into the thermoplastic composite significantly reduces the CTE. Comparing Example 3 to the commercially available products of Examples 4 and 5, it can be seen that Example 3 has a lower CTE value and a reduced permittivity at 10 gigahertz.

### Examples 6-11

The thermoplastic composites of Examples 6 to 11 were prepared in the amounts shown in Table 4 and the properties of the respective thermoplastic composites were measured.

TABLE 4

| Examples | 2 | 3 | 6 | 7 | 8 | 9 | 10 | 11 |
|---|---|---|---|---|---|---|---|---|
| Polypropylene | 69 | 65 | 69 | 65 | 65 | 65 | 65 | 65 |
| (wt %) | | | | | | | | |
| NE Glass fibers | 31 | 31 | — | — | 35 | — | 31 | — |
| (wt %) | | | | | | | | |
| E Glass fibers | — | — | 31 | 31 | — | 35 | — | 31 |
| (wt %) | | | | | | | | |
| Max CT Nanoclay | — | 4 | — | 4 | — | — | — | — |
| (wt %) | | | | | | | | |
| Cloisite 20 | — | — | — | — | — | — | 4 | 4 |
| Nanoclay | | | | | | | | |
| (wt %) | | | | | | | | |

Properties

| | | | | | | | | |
|---|---|---|---|---|---|---|---|---|
| Mixing torque | 476 | 389 | 288 | 361 | 370 | 299 | 388 | 387 |
| (mg) | | | | | | | | |
| MFI | 15.3 | 23.6 | 32.3 | 10.4 | 22.0 | 30.7 | 10.1 | 11.4 |
| (g/10 min) | | | | | | | | |
| MVR | 13.6 | 21.1 | 28.8 | 9.0 | 19.6 | 26.3 | 9.0 | 9.8 |
| (cc/10 min) | | | | | | | | |
| CTE | 37 | 18 | 23 | 29 | 95 | 64 | 73 | 33 |
| (ppm/° C.) | | | | | | | | |
| Permittivity at | 2.56 | 2.61 | 2.67 | 2.72 | 2.58 | 2.71 | 2.64 | 2.68 |
| 10 GHz | | | | | | | | |
| Dielectric loss | 0.002 | 0.003 | 0.003 | 0.003 | 0.004 | 0.004 | 0.003 | 0.003 |
| at 10 GHz | | | | | | | | |

Table 4 shows that the thermoplastic composite of Example 4 displayed the lowest CTE value while maintaining good flow properties and good dielectric properties at 10 gigahertz. Comparing to Example 7 that included E glass fibers instead of NE glass fibers, the CTE value of Example 3 was reduced by almost 40%. Comparing to Example 10 that included Cloisite 20 nanoclay instead of the Max CT nanoclay, the CTE value of Example 3 was reduced by almost 75%.

Set forth below are non-limiting aspects of the present disclosure.

Aspect 1: A thermoplastic composite comprising: 50 to 80 weight percent, or 55 to 70 weight percent of a polypropylene based on the total weight to the thermoplastic composite; 10 to 45 weight percent, or 25 to 35 weight percent a plurality of glass fibers based on the total weight of the thermoplastic composite; wherein the glass fibers comprise greater than or equal to 12 weight percent, or 15 to 25 weight percent of boric acid (B₂O₃) and less than or equal to 15 weight percent, or 0 to 10 weight percent, or 0 to 1 weight percent of CaO, both based on the total weight of the glass fibers; a plurality of clay platelets; wherein an average value of the maximum length of the platelets is less than or equal to 200 nanometers, or 75 to 150 nanometers; wherein an average thickness of the clay platelets is 1 to 10 nanometers, or 1 to 5 nanometers; and a plurality of clay rods; wherein an average value of the length of the clay rods is 50 to 600 nanometers, or 100 to 500 nanometers; and an average value of the diameter of the clay rods is 5 to 70 nanometers, or 10 to 50 nanometers; and wherein the thermoplastic composite comprises 0.5 to 10 weight percent, or 1 to 5 weight percent of the of the sum of the plurality of clay platelets and the plurality of the clay nanorods based on the total weight of the thermoplastic composite.

Aspect 2: The thermoplastic composite of Aspect 1, wherein the thermoplastic composite has a coefficient of thermal expansion of less than or equal to 30 parts per million, or 15 to 25 parts per million per degree Celsius as determined in accordance with ASTM E1545-11(2016) at 40 to 100° C.

Aspect 3: The thermoplastic composite of any of the preceding aspects, wherein the polypropylene is a copolymer including repeat units derived from ethylene.

Aspect 4: The thermoplastic composite of any of the preceding aspects, wherein the glass fibers have at least one of an average length of 0.5 to 50 millimeters, or 1 to 25 mm, or 5 to 10 mm; or an average fiber diameter of the glass fibers can be 2 to 50 micrometers, or 10 to 15 micrometers.

Aspect 5: The thermoplastic composite of any of the preceding aspects, wherein at least one of the plurality of aspect platelets or the plurality of clay rods comprises montmorillonite.

Aspect 6: The thermoplastic composite of any of the preceding aspects, wherein the thermoplastic composite has a porosity of 1 to 80 volume percent, or 10 to 50 volume percent based on the total volume of the thermoplastic composite.

Aspect 7: The thermoplastic composite of any of the preceding aspects, further comprising at least one of a hydrogen terminated nanodiamond, polyhedral oligomeric silsesquioxane, silica, or wollastonite.

Aspect 8: An article comprising: an antenna array; a reflecting layer located on a surface of the antenna array; and a spacer layer comprising a thermoplastic component located in between the antenna array and the reflecting layer, wherein the thermoplastic composite comprises a thermoplastic polymer comprising at least one of a polyolefin, a poly(phenylene ether), a polymethylpentene, or a syndiotactic polystyrene; a plurality of glass fibers; a plurality of clay platelets; and a plurality of clay rods; wherein the thermoplastic composite is optionally the thermoplastic composite of any one of the foregoing aspects.

Aspect 9: The article of Aspect 8, wherein the thermoplastic composite has a coefficient of thermal expansion of less than or equal to 30 parts per million per degree Celsius, or 15 to 25 parts per million per degree Celsius as determined in accordance with ASTM E1545-11(2016) at 40 to 100° C.

Aspect 10: The article of any one of Aspects 8 to 9, wherein the thermoplastic polymer comprises a polypropylene that includes repeat units derived from ethylene.

Aspect 11: The article of any one of Aspects 8 to 10, wherein the thermoplastic polymer is present in an amount of 50 to 80 weight percent, or 55 to 70 weight percent of the thermoplastic polymer based on the total weight of the thermoplastic composite.

Aspect 12: The article of any one of Aspects 8 to 11, wherein the glass fibers comprise at least one of pure silica glass fibers or quartz fibers; or wherein the glass fibers comprise greater than or equal to 12 weight percent, or 15 to 25 weight percent of boric acid (B₂O₃) and less than or equal to 15 weight percent, or 0 to 10 weight percent, or 0 to 1 weight percent of CaO, both based on the total weight of the glass fibers.

Aspect 13: The article of any one of Aspects 8 to 12, wherein the glass fibers have at least one of an average length of 0.5 to 50 millimeters, or 1 to 25 mm, or 5 to 10 mm; or an average fiber diameter of the glass fibers can be 2 to 50 micrometers, or 10 to 15 micrometers.

Aspect 14: The article of any one of Aspects 8 to 13, wherein at least one of the plurality of platelets or the plurality of clay rods comprises montmorillonite.

Aspect 15: The article of any one of Aspects 8 to 14, wherein an average value of the maximum length of the platelets is less than or equal to 200 nanometers, or 75 to 150 nanometers; or wherein an average thickness of the clay platelets is 1 to 10 nanometers, or 1 to 5 nanometers.

Aspect 16: The article of any one of Aspects 8 to 15, wherein an average value of the length of the clay rods is 50 to 600 nanometers, or 100 to 500 nanometers; or wherein an average value of the diameter of the clay rods is 5 to 70 nanometers, or 10 to 50 nanometers.

Aspect 17: The article of any one of Aspects 8 to 16, wherein the thermoplastic composite comprises 0.5 to 10 weight percent, or 1 to 5 weight percent of the of the sum of the plurality of clay platelets and the plurality of the clay nanorods based on the total weight of the thermoplastic composite.

Aspect 18: The article of any one of Aspects 8 to 17, wherein the thermoplastic composite has a porosity of 1 to 80 volume percent, or 10 to 50 volume percent based on the total volume of the thermoplastic composite.

Aspect 19: The article of any one of Aspects 8 to 18, further comprising at least one of a hydrogen terminated nanodiamond, polyhedral oligomeric silsesquioxane, silica, or wollastonite.

Aspect 20: An article comprising: an antenna array; a reflecting layer located on a surface of the antenna array; and a spacer layer comprising a thermoplastic component located in between the antenna array and the reflecting layer; wherein the thermoplastic composite comprises 55 to 70 weight percent of polypropylene; 25 to 35 weight percent of a plurality of glass fibers; wherein the glass fibers have at least one of an average length of 0.5 to 50 millimeters, or 1 to 25 mm, or 5 to 10 mm, or an average fiber diameter of the glass fibers can be 2 to 50 micrometers, or 10 to 15 micrometers; and wherein the glass fibers comprise greater than or equal to 12 weight percent, or 15 to 25 weight percent of boric acid and less than or equal to 15 weight percent, or 0 to 10 weight percent, or 0 to 1 weight percent of CaO, both based on the total weight of the glass fibers; a plurality of clay platelets; wherein an average value of the maximum length of the platelets is less than or equal to 200 nanometers, or 75 to 150 nanometers; or wherein an average thickness of the clay platelets is 1 to 10 nanometers, or 1 to 5 nanometers; and a plurality of clay rods; wherein an average value of the length of the clay rods is 50 to 600 nanometers, or 100 to 500 nanometers; or wherein an average value of the diameter of the clay rods is 5 to 70 nanometers, or 10 to 50 nanometers; and wherein the thermoplastic composite comprises 0.5 to 10 weight percent, or 1 to 5 weight percent of the of the sum of the plurality of clay platelets and the plurality of the clay nanorods based on the total weight of the thermoplastic composite; and wherein the thermoplastic composite has a coefficient of thermal expansion of less than or equal to 30 parts per million, or 15 to 25 parts per million per degree Celsius as determined in accordance with ASTM E1545-11(2016) at 40 to 100° C.

The compositions, methods, and articles can alternatively comprise, consist of, or consist essentially of, any appropriate materials, steps, or components herein disclosed. The compositions, methods, and articles can additionally, or alternatively, be formulated so as to be devoid, or substantially free, of any materials (or species), steps, or components, that are otherwise not necessary to the achievement of the function or objectives of the compositions, methods, and articles.

As used herein, “a,” “an,” “the,” and “at least one” do not denote a limitation of quantity, and are intended to cover both the singular and plural, unless the context clearly indicates otherwise. For example, “an element” has the same meaning as “at least one element,” unless the context clearly indicates otherwise. The term “combination” is inclusive of blends, mixtures, alloys, reaction products, and the like. Also, “at least one of” means that the list is inclusive of each element individually, as well as combinations of two or more elements of the list, and combinations of at least one element of the list with like elements not named. The term “or” means “and/or” unless clearly indicated otherwise by context. Reference throughout the specification to “an aspect”, “another aspect”, “some aspects”, and so forth, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

Unless specified to the contrary herein, all test standards are the most recent standard in effect as of the filing date of this application, or, if priority is claimed, the filing date of the earliest priority application in which the test standard appears.

The endpoints of all ranges directed to the same component or property are inclusive of the endpoints, are independently combinable, and include all intermediate points and ranges. For example, ranges of “up to 25 wt %, or 5 to 20 wt %” is inclusive of the endpoints and all intermediate values of the ranges of “5 to 25 wt %,” such as 10 to 23 wt %, etc.).

Unless defined otherwise, technical and scientific terms used herein have the same meaning as is commonly understood by one of skill in the art to which this disclosure belongs. Compounds are described using standard nomenclature.

All cited patents, patent applications, and other references are incorporated herein by reference in their entirety. However, if a term in the present application contradicts or conflicts with a term in the incorporated reference, the term from the present application takes precedence over the conflicting term from the incorporated reference.

While particular embodiments have been described, alternatives, modifications, variations, improvements, and substantial equivalents that are or may be presently unforeseen may arise to applicants or others skilled in the art. Accordingly, the appended claims as filed and as they may be amended are intended to embrace all such alternatives, modifications variations, improvements, and substantial equivalents.

What is claimed is:

1. A thermoplastic composite comprising:
50 to 80 weight percent of a polypropylene based on the total weight to the thermoplastic composite;
10 to 45 weight percent a plurality of glass fibers based on the total weight of the thermoplastic composite; wherein the glass fibers comprise greater than or equal to 12 weight percent of boric acid (B₂O₃) and less than or equal to 15 weight percent of CaO, both based on the total weight of the glass fibers;
a plurality of clay platelets; wherein an average value of the maximum length of the platelets is less than or equal to 200 nanometers; wherein an average thickness of the clay platelets is 1 to 10 nanometers; and
a plurality of clay rods; wherein an average value of the length of the clay rods is 50 to 600 nanometers; and an average value of the diameter of the clay rods is 5 to 70 nanometers; and
wherein the thermoplastic composite comprises 0.5 to 10 weight percent of the of the sum of the plurality of clay platelets and the plurality of the clay nanorods based on the total weight of the thermoplastic composite.

2. The thermoplastic composite of claim 1, wherein the thermoplastic composite has a coefficient of thermal expansion of less than or equal to 30 parts per million per degree Celsius as determined in accordance with ASTM E1545-11(2016) at 40 to 100° C.

3. The thermoplastic composite of claim 1, wherein the polypropylene is a copolymer including repeat units derived from ethylene.

4. The thermoplastic composite of claim 1, wherein the glass fibers have at least one of an average length of 0.5 to 50 millimeters; or an average fiber diameter of the glass fibers can be 2 to 50 micrometers.

5. The thermoplastic composite of claim 1, wherein at least one of the plurality of claim platelets or the plurality of clay rods comprises montmorillonite.

6. The thermoplastic composite of claim 1, wherein the thermoplastic composite has a porosity of 1 to 80 volume percent based on the total volume of the thermoplastic composite.

7. The thermoplastic composite of claim 1, further comprising at least one of a hydrogen terminated nanodiamond, polyhedral oligomeric silsesquioxane, silica, or wollastonite.

8. An article comprising:
an antenna array;
a reflecting layer located on a surface of the antenna array; and
a spacer layer comprising a thermoplastic component located in between the antenna array and the reflecting layer;
wherein the thermoplastic composite comprises
a thermoplastic polymer comprising at least one of a polyolefin, a poly(phenylene ether), a polymethylpentene, or a syndiotactic polystyrene;
a plurality of glass fibers;
a plurality of clay platelets; and
a plurality of clay rods;
wherein the thermoplastic composite is optionally the thermoplastic composite of any one of the foregoing claims.

9. The article of claim 8, wherein the thermoplastic composite has a coefficient of thermal expansion of less than or equal to 30 parts per million per degree Celsius as determined in accordance with ASTM E1545-11(2016) at 40 to 100° C.

10. The article of claim 8, wherein the thermoplastic polymer comprises a polypropylene that includes repeat units derived from ethylene.

11. The article of claim 8, wherein the thermoplastic polymer is present in an amount of 50 to 80 weight percent of the thermoplastic polymer based on the total weight of the thermoplastic composite.

12. The article of claim 8, wherein the glass fibers comprise at least one of pure silica glass fibers or quartz fibers; or wherein the glass fibers comprise greater than or equal to 12 weight percent boric acid (B₂O₃) and less than or equal to 15 weight percent of CaO, both based on the total weight of the glass fibers.

13. The article of claim 8, wherein the glass fibers have at least one of an average length of 0.5 to 50 millimeters; or an average fiber diameter of the glass fibers can be 2 to 50 micrometers.

14. The article of claim 8, wherein at least one of the plurality of the platelets or the plurality of clay rods comprises montmorillonite.

15. The article of claim 8, wherein an average value of the maximum length of the platelets is less than or equal to 200 nanometers; or wherein an average thickness of the clay platelets is 1 to 10 nanometers.

16. The article of claim 8, wherein an average value of the length of the clay rods is 50 to 600 nanometers; or wherein an average value of the diameter of the clay rods is 5 to 70 nanometers.

17. The article of claim 8, wherein the thermoplastic composite comprises 0.5 to 10 weight percent of the of the sum of the plurality of clay platelets and the plurality of the clay nanorods based on the total weight of the thermoplastic composite.

18. The article of claim 8, wherein the thermoplastic composite has a porosity of 1 to 80 volume percent based on the total volume of the thermoplastic composite.

19. The article of claim 8, further comprising at least one of a hydrogen terminated nanodiamond, polyhedral oligomeric silsesquioxane, silica, or wollastonite.

20. An article comprising:
an antenna array;
a reflecting layer located on a surface of the antenna array; and
a spacer layer comprising a thermoplastic component located in between the antenna array and the reflecting layer;
wherein the thermoplastic composite comprises
55 to 70 weight percent of polypropylene;
25 to 35 weight percent of a plurality of glass fibers; wherein the glass fibers have at least one of an average length of 0.5 to 50 millimeters, or an average fiber diameter of the glass fibers can be 2 to 50 micrometers; and wherein the glass fibers comprise greater than or equal to 12 weight percent of boric acid and less than or equal to 15 weight percent of CaO, both based on the total weight of the glass fibers;
a plurality of clay platelets; wherein an average value of the maximum length of the platelets is less than or equal to 200 nanometers; or wherein an average thickness of the clay platelets is 1 to 10 nanometers; and
a plurality of clay rods; wherein an average value of the length of the clay rods is 50 to 600 nanometers; or wherein an average value of the diameter of the clay rods is 5 to 70 nanometers; and
wherein the thermoplastic composite comprises 0.5 to 10 weight percent of the of the sum of the plurality of clay platelets and the plurality of the clay nanorods based on the total weight of the thermoplastic composite; and
wherein the thermoplastic composite has a coefficient of thermal expansion of less than or equal to 30 parts per million per degree Celsius as determined in accordance with ASTM E1545-11(2016) at 40 to 100° C.
